(19) United States
(12) Patent Application Publication
(10) Pub. No.: US 2016/0361753 A1
(43) Pub. Date: Dec. 15, 2016

(54) METHOD OF TUNING PANELS FOR COMMONALITY OF SELF-PIERCING RIVET/DIE AND ROBOT COMBINATIONS

(71) Applicant: Ford Motor Company, Dearborn, MI (US)

(72) Inventors: Dragan B. Stojkovic, Taylor, MI (US); Colleen Marie Hoffman, Canton, MI (US)

(21) Appl. No.: 14/736,305

(22) Filed: Jun. 11, 2015

(51) Int. Cl. B21J 15/02; B32B 7/08; B32B 3/30; B32B 15/01

(52) U.S. Cl. CPC B21J 15/025; B32B 15/016; B32B 7/08; B32B 3/30; B32B 2307/58

(57) ABSTRACT

A method is provided for preparing a plurality of material stacks for joining with common self-piercing rivets. The method includes tuning the panels for self-piercing rivet joint commonality and manufacturing simplicity by providing each of the multiple material stacks with a common self-piercing rivet mating surface thickness. This may be done by striking a metal panel of an individual material stack at a self-piercing rivet mating surface to reduce the thickness thereof in a tuned area and thereby provide the common self-piercing rivet mating surface thickness to the individual material stack independent of the original total metal thickness of the individual material stack.

### TECHNICAL FIELD

This document relates generally to the manufacture and assembly field and, more specifically, relates to a method for localized panel tuning across multiple joint stack thicknesses for rivet/die commonality and manufacturing efficiency.

### BACKGROUND

Assembly line and manufacturing complexity may be reduced by limiting the number of self-piercing rivet (SPR) gun and robot combinations required for any given assembly/manufacturing application. Toward this end, it must be realized that self-piercing rivets are specifically designed to stake or join a material stack of a particular thickness.

Three joints are shown in FIG. 1: Joint 1, Joint 2, and Joint 3. Each joint comprises two panels. The first joint includes panel P₁ and panel P₂, the second joint includes panel P₃ and panel P₄ and the third joint includes panel P₅ and panel P₆. As illustrated, panels P₂, P₄ and P₆ share a common thickness while panel P₁ has a thickness greater than panel P₃ which has a thickness greater than panel P₅. As a consequence, the self-piercing rivet mating surface thickness T₁ of Joint 1 is greater than the self-piercing rivet mating surface thickness T₂ of Joint 2 which is greater than the self-piercing rivet mating surface thickness T₃ of Joint 3. As should be appreciated, each different self-piercing rivet mating surface thickness T₁, T₂, T₃ requires a different rivet/die and robot combinations in order to complete the assembly.

This document relates to a method, as well as a metal panel providing localized tuning at the self-piercing rivet mating surface of a material stack so as to provide a common self-piercing rivet mating surface thickness for multiple stacks thereby allowing those multiple stacks to be joined utilizing a single rivet/die and robot combination. Advantageously, this approach provides a number of distinct advantages including, but not necessarily limited to, a reduction in joint development costs, the maintaining of joining feasibility during production change, the maintaining of manufacturing flexibility/commonality, the reduction of manufacturing costs, the reduction of manufacturing complexity, the reduction of assembly-line investment and the advantages of common rivet/die tooling.

### SUMMARY

In accordance with the purposes and benefits described herein, a method is provided for preparing a plurality of material stacks for joining with common self-piercing rivets. That method may be described as comprising the steps of: (a) determining a target, common self-piercing rivet mating surface thickness for the plurality of material stacks and (b) striking at least one metal panel of a first individual material stack at a self-piercing rivet mating surface to reduce thickness thereof in a tuned area and provide the target self-piercing rivet mating surface thickness to the first individual material stack independent of the original total metal thickness of the first individual material stack.

In one possible embodiment, the method further includes forming transitional stiffeners in the tuned area during striking in order to take up displaced metal and minimize distortion around the tuned area. This may include radially arranging the transitional stiffeners relative to a point in the tuned area.

In accordance with one possible embodiment, the method further includes striking at least one metal panel of a second individual material stack at a self-piercing rivet mating surface to reduce thickness thereof in a second tuned area and provide the target self-piercing rivet mating surface thickness to the second individual material stack independent of the original total metal thickness of the second individual material stack.

In one possible embodiment, this method may further include forming second transitional stiffeners in the second tuned area during striking in order to take up displaced metal and minimize distortion around the second tuned area.

Further, the method may include identifying the material stack of the plurality of material stacks having the thinnest self-piercing rivet mating surface thickness based upon original total metal thickness of the plurality of material stacks and selecting the thinnest self-piercing rivet mating surface thickness as the target self-piercing rivet mating surface thickness for all of the material stacks.

In accordance with an additional aspect, this document describes and relates to a method utilized in a manufacturing process including multiple material stacks. That method comprises tuning panels for self-piercing rivet joint commonality and manufacturing simplicity by providing each of the multiple material stacks with a common self-piercing rivet mating surface thickness. More specifically, this method includes localized striking of a metal panel of an individual material stack at a self-piercing rivet mating surface to reduce the thickness thereof in a tuned area and provide the common self-piercing rivet mating surface thickness to the individual material stack independent of the original total metal thickness of the individual material stack.

Still further, the method includes forming transitional stiffeners in the tuned area during striking in order to take up displaced metal and minimize distortion around the tuned area.

In accordance with still another aspect, a metal panel is provided for joining into a material stack with self-piercing rivets. That metal panel comprises a formed sheet having a tuned area of reduced thickness forming a self-piercing rivet mating surface for receiving a self-piercing rivet.

In one possible embodiment, the tuned area includes a bottom wall and a sidewall. Further, the metal panel includes a plurality of transitional stiffeners extending between the sidewall and the bottom wall of the tuned area. Those plurality of transitional stiffeners may be radially arrayed around the tuned area forming spaced gussets between the sidewall and the bottom wall. Still further in one possible embodiment, the panel is made from aluminum or aluminum alloy.

In accordance with yet another aspect, a material stack is provided incorporating the metal panel as described.

In the following description, there are shown and described several preferred embodiments of the manufacturing method and tuned panel. As it should be realized, the manufacturing method and tuned panel are capable of other, different embodiments and their several details are capable of modification in various, obvious aspects all without departing from the method and panel as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the manufacturing method and tuned panel and together with the description serve to explain certain principles thereof. In the drawing figures:

FIG. 1 illustrates three material stack joints and three different self-piercing rivet mating surface thicknesses requiring three different rivet/die and robot combinations in order to complete assembly.

FIG. 2 illustrates the same three joints tuned in accordance with the teachings of this document in order to have a target, common self-piercing rivet mating surface thickness allowing all three joints to be joined by means of a single rivet/die and robot combination.

FIG. 3 is a perspective view illustrating how a panel may be tuned to accommodate a design change requiring a larger gauge panel while still maintaining the original or common self-piercing rivet mating surface thickness so that the material stack may still be joined by the same rivet/die and robot combination utilized to join the original material stack.

FIGS. 4a-4c illustrate the striking of a panel of the material stack in order to provide a tuned area for maintaining a target, common self-piercing rivet mating surface thickness of the material stack in which the panel is provided.

FIG. 5 is a detailed perspective view illustrating a tuned area provided in a panel incorporating a sidewall, a bottom wall and a plurality of transitional stiffeners extending between the sidewall and bottom wall so as to form spaced gussets therebetween.

Reference will now be made in detail to the present preferred embodiments of the method and tuned panel, examples of which are illustrated in the accompanying drawing figures.

### DETAILED DESCRIPTION

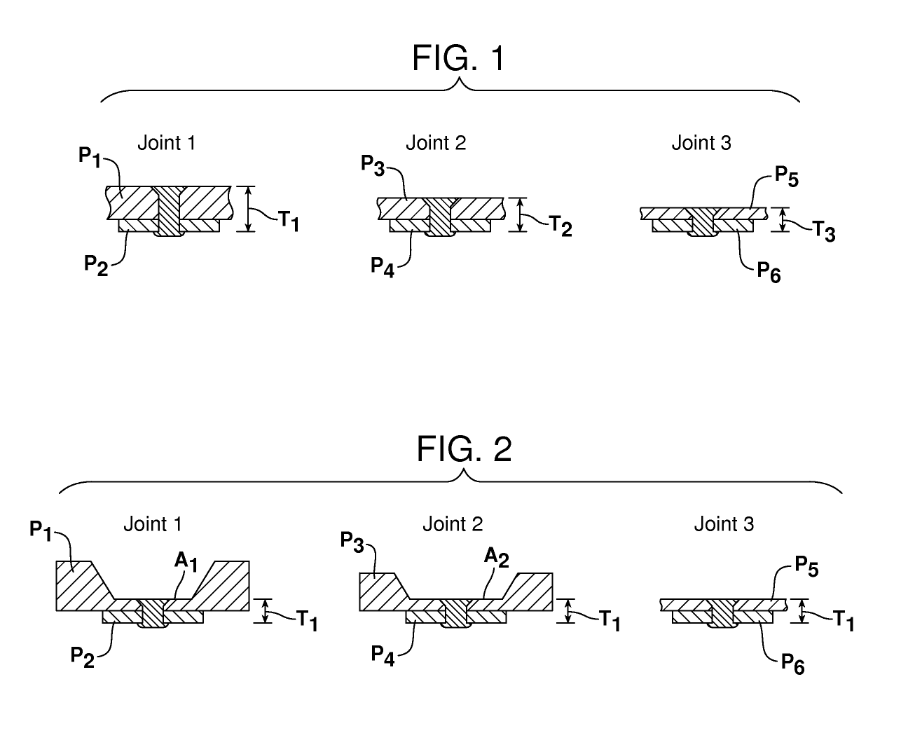

Reference is now again made to FIG. 1 illustrating three different joints, Joint 1, Joint 2 and Joint 3 which include three different self-piercing rivet mating surface thicknesses T₁, T₂, T₃ which all require separate or individual rivet/die and robot combinations. The requirement of three different rivet/die and robot combinations in order to complete the three joints significantly adds to manufacturing investment, complexity and production costs.

These problems are overcome by tuning at least one panel P₁ in the material stack to provide for self-piercing rivet joint commonality and manufacturing simplicity. More specifically, this is done by providing each of the material stacks with a common self-piercing rivet mating surface thickness. As illustrated in FIG. 2, panel P₁ incorporates a tuned area A₁ which provides a self-piercing rivet mating surface thickness T₁. Similarly, panel P₃ is provided with a tuned area A₂ which provides an overall self-piercing rivet mating surface thickness T₁.

As it should be appreciated, the self-piercing rivet mating surface thickness T₁ is now shared by all three material stacks at Joints 1, 2 and 3 so that all three material stacks may be joined utilizing a single rivet/die and robot combination.

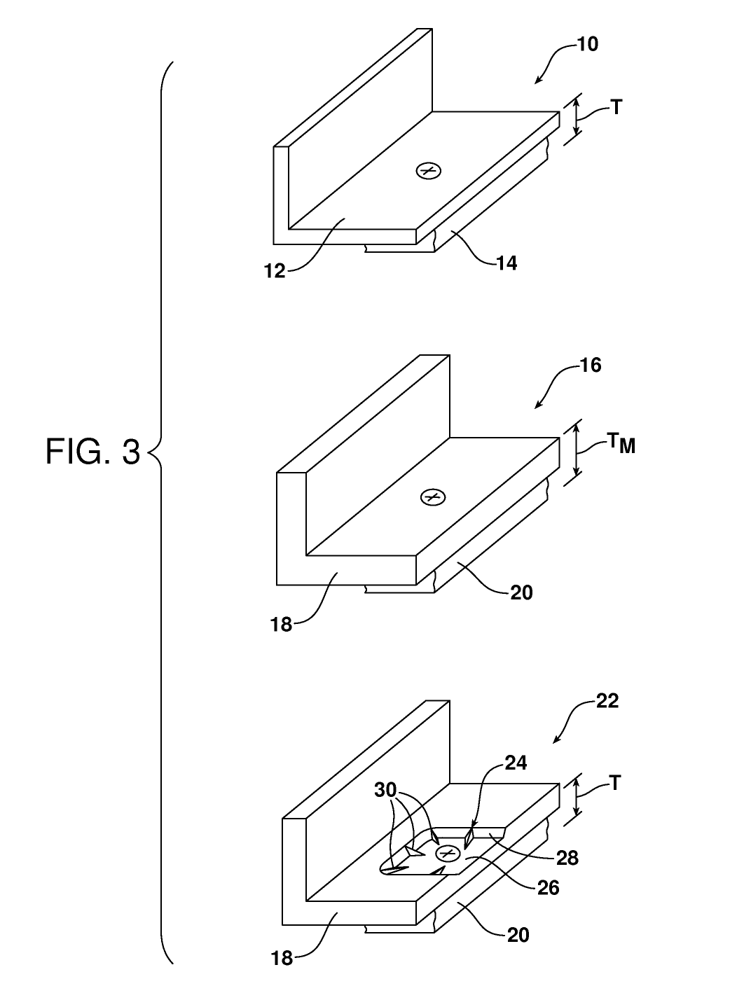

Reference is now made to FIG. 3 illustrating at the top a material stack 10 incorporating a first panel 12 and a second panel 14 wherein the panels are of a gauge of original design requiring a particular rivet/die and robot combination in order to complete the joining of the panels.

As further illustrated in FIG. 3, a second material stack 16 includes a first panel 18 and a second panel 20. A design change has been made and, as a consequence, the first panel 18 of the second material stack 16 is of a greater gauge than the first panel 12 of the first material stack 10. As a consequence, the self-piercing rivet mating surface thickness T_{M} of the second stack 16 is greater than the self-piercing rivet mating surface thickness T of the first material stack 10. This increase in thickness would necessitate a change in the assembly line to accommodate the change in design. More specifically, a different rivet/die and robot combination would be required to complete the joining of the panels 18, 20 of the second stack 16 versus the panels 12, 14 of the first stack 10.

In order to avoid this complication, the third material stack 22 illustrated in FIG. 3 incorporates the first panel 18 with the new, heavier gauge and the second panel 20 as provided in the second stack 16. However, it should be appreciated that the first panel 18 incorporates a tuned area generally designate by reference numeral 24. That tuned area 24 includes a bottom wall 26, a sidewall 28 and a series transitional stiffeners 30.

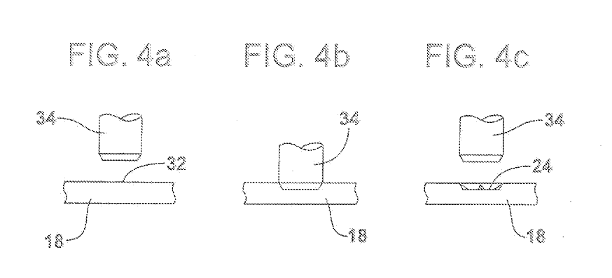

Reference is now made to FIG. 4 illustrating how the panel 18 is tuned.

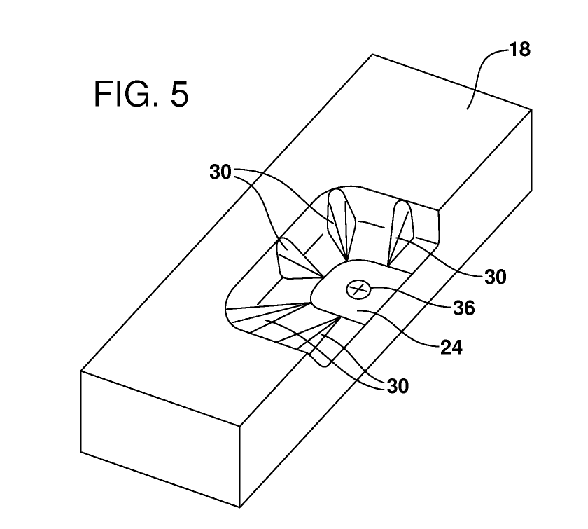

First, a target, common self-piercing rivet mating surface thickness is determined. As illustrated in FIGS. 4a-4c, this is followed by striking the metal panel 18 at the self-piercing rivet mating surface 32 with a punch or a die 34 to reduce the thickness thereof in the tuned area 24 and provide a target self-piercing rivet mating surface thickness to the material stack 22 in which the panel 18 is provided independent of the original total metal thickness of the material stack. As illustrated in FIGS. 4c and 5, this includes forming the transitional stiffeners 30 in the tuned area 24 during striking. The stiffeners 30 take up displaced metal and minimize distortion around the tuned area 24. Such an approach is particularly useful when the panel 18 is made from aluminum or aluminum alloy.

In the embodiment illustrated in FIG. 5, the transitional stiffeners 30 are radially arrayed around a point 36 in the tuned area 24 which happens to be the centerline for the joining rivet.

Numerous benefits result from employing the method and tuned panel 18 disclosed herein. Commonality of self-piercing rivet mating surface thickness may be maintained between multiple material stacks. It is possible to maintain that commonality even when design modifications require the use of a panel of a new, thicker gauge. This is accomplished by simply striking the modified gauge panel to provide a tuned area 24 as described. As a result, joint development costs are reduced and joint feasibility during production change is maintained. Further, manufacturing flexibility/commonality is maintained while manufacturing costs, manufacturing complexity and assembly line investment are all reduced.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of preparing a plurality of material stacks for joining with common self-piercing rivets, comprising:
determining a target common self-piercing rivet mating surface thickness for the plurality of material stacks; and
striking at least one metal panel of a first individual material stack at a self-piercing rivet mating surface to reduce thickness thereof in a tuned area and provide said target self-piercing rivet mating surface thickness to said first individual material stack independent of original total metal thickness of said first individual material stack.

2. The method of claim 1, further including forming transitional stiffeners in said tuned area during striking in order to take up displaced metal and minimize distortion around said tuned area.

3. The method of claim 2, further including radially arranging said transitional stiffeners relative to a point in said tuned area.

4. The method of claim 2, further including striking at least one metal panel of a second individual material stack at a self-piercing rivet mating surface to reduce thickness thereof in a second tuned area and provide said target self-piercing rivet mating surface thickness to said second individual material stack independent of original total metal thickness of said second individual material stack.

5. The method of claim 4, further including forming second transitional stiffeners in said second tuned area during striking in order to take up displaced metal and minimize distortion around said second tuned area.

6. The method of claim 1, including identifying which material stack of said plurality of material stacks having thinnest self-piercing rivet mating surface thickness based upon original total metal thickness of said plurality of material stacks and selecting said thinnest self-piercing rivet mating surface thickness as said target self-piercing mating surface thickness.

7. In a manufacturing process including multiple material stacks, a method, comprising:
tuning panels for self-piercing rivet joint commonality and manufacturing simplicity by providing each of said multiple material stacks with a common self-piercing rivet mating surface thickness.

8. The method of claim 7, including localized striking of a metal panel of an individual material stack at a self-piercing rivet mating surface to reduce thickness thereof in a tuned area and provide said common self-piercing rivet mating surface thickness to said individual material stack independent of original total metal thickness of said individual material stack.

9. The method of claim 8, including forming transitional stiffeners in said tuned area during striking in order to take up displaced metal and minimize distortion around said tuned area.

10. A metal panel for joining into a material stack with self-piercing rivets, comprising:
a formed sheet having a tuned area of reduced thickness forming a self-piercing rivet mating surface for receiving a self-piercing rivet.

11. The metal panel of claim 10, wherein said tuned area includes a bottom wall and a sidewall.

12. The metal panel of claim 11, further including a plurality of transitional stiffeners extending between said sidewall and said bottom wall of said tuned area.

13. The metal panel of claim 12, wherein said plurality of transitional stiffeners are radially arrayed around said tuned area forming spaced gussets between said sidewall and said bottom wall.

14. The metal panel of claim 13, wherein said panel is made from a material selected from a group consisting of aluminum and aluminum alloy.

15. The metal panel of claim 11, wherein said panel is made from a material selected from a group consisting of aluminum and aluminum alloy.

16. The metal panel of claim 12, wherein said panel is made from a material selected from a group consisting of aluminum and aluminum alloy.

17. A material stack incorporating the metal panel of claim 10.
